(19) United States
(12) Patent Application Publication
(10) Pub. No.: US 2015/0029425 A1
(43) Pub. Date: Jan. 29, 2015

(54) AUTO-STEREOSCOPIC DISPLAY DEVICE

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 13/951,568

(22) Filed: Jul. 26, 2013

(51) Int. Cl. G02B 27/22

(52) U.S. Cl. CPC G02B 27/2214
USPC 349/15

(57) ABSTRACT

An auto-stereoscopic display device includes an image display module, a parallax barrier, a camera, and a processor. The image display module includes left eye pixels and right eye pixels arranged alternately. The parallax barrier includes opaque parts and light-transmissible parts arranged alternately. The camera is configured to capture an image in front of the auto-stereoscopic display device. The processor includes a face identifying module configured to determine whether a face exists in the image and determine a position of the face in the image when the face exists in the image, and a parallax barrier adjusting module configured to adjust positions of the opaque parts and the light-transmissible parts according to the position of the face in the image, so that a left eye is only capable of seeing the left eye pixels, and a right eye is only capable of seeing the right eye pixels.

### BACKGROUND

1. Technical Field

The present disclosure relates to an auto-stereoscopic display device.

2. Description of Related Art

FIG. 1 shows an auto-stereoscopic display device 10. The auto-stereoscopic display device 10 includes an image display module 11 and a parallax barrier 15. The image display module 11 includes right eye pixels 12 and left eye pixels 13 arranged alternately. The parallax barrier 15 includes opaque parts 16 and light-transmissible parts 17 arranged alternately. When a viewer is located in a predetermined viewing position (as shown in solid lines in FIG. 1), a right eye 18 can only see the right eye pixels 12 through the light-transmissible parts 17, and cannot see the left eye pixels 13 because of the barrier of the opaque parts 16; a left eye 19 can only see the left eye pixels 13 through the light-transmissible parts 17, and cannot see the right eye pixels 12 because of the barrier of the opaque parts 16. A human brain of the viewer combines the left eye pixels 13 and the right eye pixels 12 to obtain a stereoscopic image. Yet, when a viewer is located out of the predetermined viewing position (as shown in broken lines in FIG. 1), the left eye and the right eye can both see the left eye pixels 13 and the right eye pixels 12, and the auto-stereoscopic display device becomes useless.

Therefore, it is desirable to provide an auto-stereoscopic display device which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an auto-stereoscopic display device according to a related art.

FIG. 2 is a schematic, exploded view of an auto-stereoscopic display device according to an exemplary embodiment of the present disclosure.

FIGS. 3 and 4 are schematic views of the auto-stereoscopic display device, wherein a viewer is located at different positions relative to the auto-stereoscopic display device.

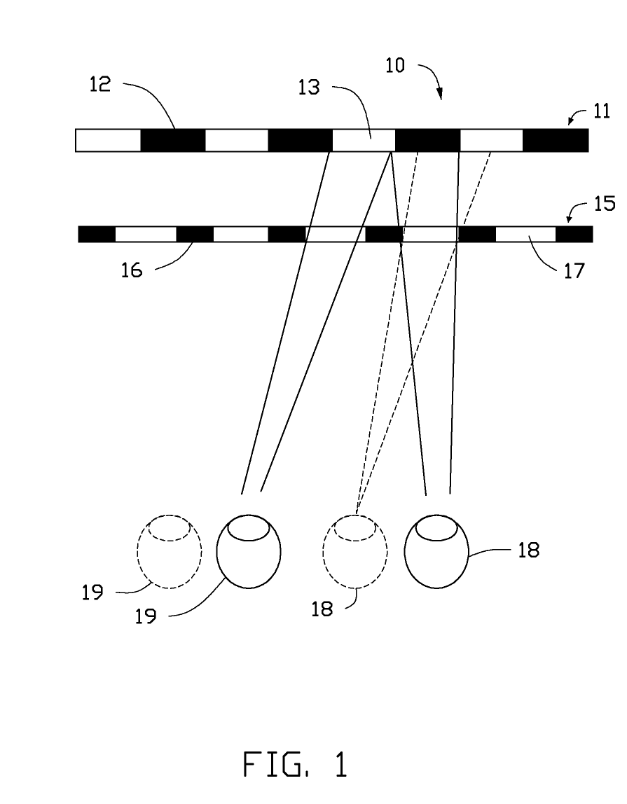

### DETAILED DESCRIPTION

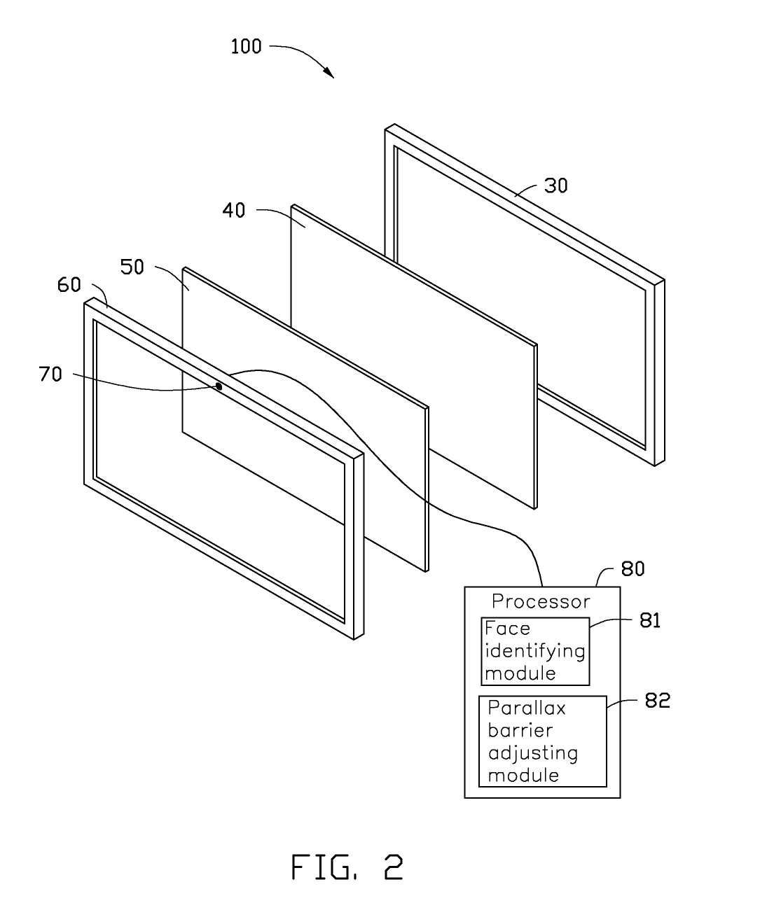

FIGS. 2 to 4 show an auto-stereoscopic display device 100. The auto-stereoscopic display device 100 includes a backlight module 30, an image display module 40, a parallax barrier 50, a frame 60, a camera 70 and a processor 80. The frame 60 is fixed to the backlight module 30. The image display module 40 and the parallax barrier 50 are received between the backlight module 30 and the frame 60. The camera 70 is mounted on the frame 60. The processor 80 is received in the display device 100, such as the backlight module 30.

The backlight module 30 includes light sources, a light guide plate, and optical films (not shown). The backlight module 30 is configured to illuminate the image display module 40 and the parallax barrier 50.

The image display module 40 includes right eye pixels 41 and left eye pixels 42 arranged alternately.

The parallax barrier 50 is a thin film transistor liquid crystal display device (TFT LCD). The parallax barrier 50 includes a number of pixels. The pixels can be controlled to be light-transmissible or opaque according to a known means. The opaque pixels form opaque parts 51. The light-transmissible pixels form light-transmissible parts 52. The opaque parts 51 and the light-transmissible parts 52 are arranged alternately. Positions of the opaque parts 51 and the light-transmissible parts 52 are changeable.

The camera 70 is mounted on a top and middle point of the frame 60. The camera 70 is configured to capture an image in front of the auto-stereoscopic display device 100.

The processor 80 includes a face identifying module 81 and a parallax barrier adjusting module 82.

The face identifying module 81 receives the image captured by the camera 70, determines whether a face exists in the image, and determines a position of the face in the image. In detail, when the face is positioned at a center point of the image along a horizontal direction, the face identifying module 81 determines the face is at a predetermined viewing position; when the face deviates from the center point along the horizontal direction, the face identifying module 81 determines a deviation direction and a deviation level of the face relative to the predetermined viewing position.

The parallax barrier adjusting module 82 adjusts positions of the opaque parts 51 and the light-transmissible parts 52 of the parallax barrier 50 according to a determining result of the face identifying module 81.

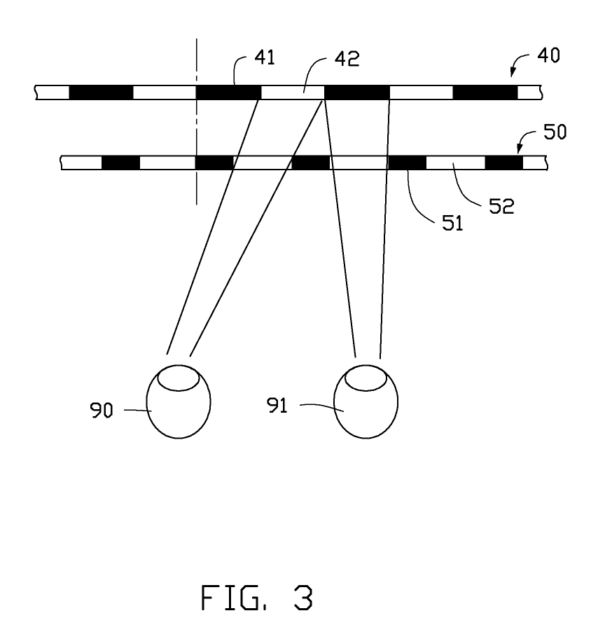

FIG. 3 shows that the determining result indicates that when the face is located at the predetermined viewing position, the parallax barrier adjusting module 82 locates the opaque parts 51 and the light-transmissible parts 52 at a predetermined distribution position. A left eye 90 can only see the left eye pixels 42 through the light-transmissible parts 52, and cannot see the right eye pixels 41 because of the barrier of the opaque parts 51. A right eye 91 can only see the right eye pixels 41 through the light-transmissible parts 52, and cannot see the left eye pixels 42 because of the barrier of the opaque parts 51.

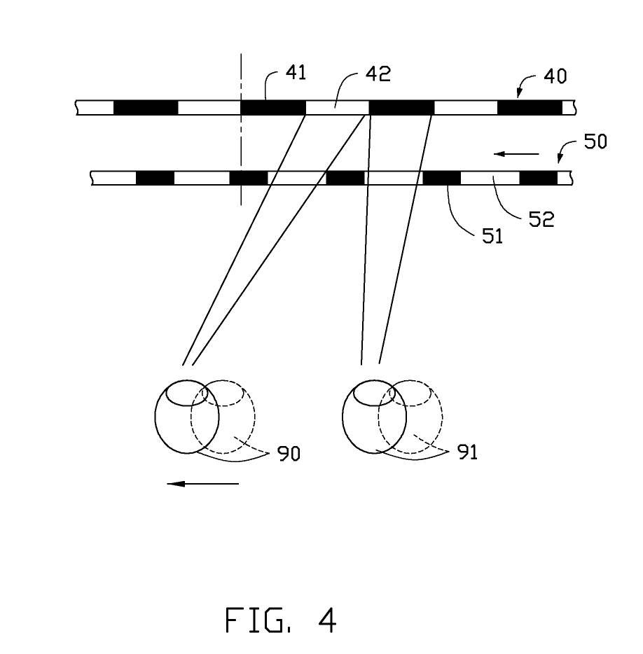

FIG. 4 shows that the determining result indicates that when the face deviates from the predetermined viewing position towards a particular direction and at a particular level, the parallax barrier adjusting module 82 changes the position of the opaque parts 51 and the light-transmissible parts 52 towards the particular direction and at the particular level relative to the predetermined distribution position. For example, when the face moves to left at one third of a full width in the image captured by the camera 70, the opaque parts 51 and the light-transmissible parts 52 move to left at one third of a full width of the parallax barrier 50. In this way, when the face deviates from the predetermined viewing position, the left eye 90 can still only see the left eye pixels 42 through the light-transmissible parts 52, and cannot see the right eye pixels 41 because of the barrier of the opaque parts 51. The right eye 91 can still only see the right eye pixels 41 through the light-transmissible parts 52, and cannot see the left eye pixels 42 because of the barrier of the opaque parts 51.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An auto-stereoscopic display device, comprising:
an image display module comprising left eye pixels and right eye pixels arranged alternately;
a parallax barrier comprising opaque parts and light-transmissible parts arranged alternately;
a camera configured to capture an image in front of the auto-stereoscopic display device; and
a processor comprising:
a face identifying module configured to determine whether a face exists in the image, and determine a position of the face in the image when the face exists in the image; and
a parallax barrier adjusting module configured to adjust positions of the opaque parts and the light-transmissible parts according to the position of the face in the image, such that a left eye is only capable of seeing the left eye pixels, and a right eye is only capable of seeing the right eye pixels.

2. The auto-stereoscopic display device of claim 1, wherein the parallax barrier is a liquid crystal display device (LCD device).

3. The auto-stereoscopic display device of claim 2, wherein the parallax barrier is a thin film transistor LCD device.

4. The auto-stereoscopic display device of claim 1, wherein when the face is located at a predetermined viewing position, the parallax barrier adjusting module adjusts the opaque parts and the light-transmissible parts to a predetermined distribution position.

5. The auto-stereoscopic display device of claim 4, wherein when the face deviates from the predetermined viewing position towards a particular direction at a particular level, the parallax barrier adjusting module moves the opaque parts and the light-transmissible parts towards the particular direction at the particular level relative to the predetermined distribution position.

6. The auto-stereoscopic display device of claim 1, comprising a backlight module.

7. The auto-stereoscopic display device of claim 6, comprising a frame fixed to the backlight module, the image display module and the parallax barrier being received between the frame and the backlight module.

8. The auto-stereoscopic display device of claim 7, wherein the camera is mounted on the frame.
